(19) United States
(12) Patent Application Publication
(10) Pub. No.: US 2002/0145333 A1
(43) Pub. Date: Oct. 10, 2002

(54) System and method for avoiding rollovers

(76) Inventor: Ian Faye, Stuttgart (DE)

Correspondence Address: KENYON & KENYON, ONE BROADWAY, NEW YORK, NY, 10004, US

(21) Appl. No.: 10/034,573

(22) Filed: Dec. 28, 2001

(30) Foreign Application Priority Data
Dec. 28, 2000 (DE) 100 65 590.4

(51) Int. Cl. B60T 13/00

(52) U.S. Cl. 303/140; 303/146

(57) ABSTRACT

A method and system for avoiding rollovers during braking of motor vehicles using an apparatus, including an arrangement or structure to reduce the braking force at at least one wheel, an apparatus, arrangement or structure to determine an angle of inclination of the vehicle and an apparatus, arrangement or structure to reduce the braking force that is activatable as a function of the angle of inclination.

### FIELD OF THE INVENTION

The present invention relates to a system for avoiding rollovers during braking of motor vehicles using an apparatus, arrangement or structure to reduce the braking force at at least one wheel, and further relates to a method for avoiding rollovers during braking, in which the braking force is reduced at at least one wheel.

### BACKGROUND INFORMATION

In motor vehicles having a comparatively long wheelbase and a fairly low center of gravity, under “normal” loading conditions there may be no danger of a rearward rollover in the event of abrupt braking while the vehicle is moving backward. It is believed, however, that there may be an increasing number of vehicles that are appearing on the market with a considerably higher center of gravity than “normal” vehicles, frequently in conjunction with a severely shortened wheelbase. In motor vehicles of this type, rearward rollovers can occur in the event of sudden braking while the vehicle is moving backward. This type of rollover will occur if the slope is extremely steep (such as may be the case, for example, with the exit from an underground garage or a ramp), and if the combination of the braking force at the rear axle with the centrifugal force at the center of gravity generates a torque which overcomes the earth's gravity.

It is understood that there may have been suggestions to lessen the problems of the danger of a rearward rollover by limiting a vehicle's rearward rolling speed, and that this may be done by detecting the vehicle's rearward rolling speed and by actuating one of the vehicle's brakes when a limit speed, which can be preset, is reached or exceeded while the vehicle is moving backward.

There may also be approaches in which the speeds of rotation of the front and rear wheels are monitored and action is taken at the vehicle's drive train when limit values are exceeded, for example, by changing the drag torque of the engine, in order to counter an imminent rollover.

Additionally, there may also be other systems which are designed for use in comparable sets of problems. For example, the tipping over of a vehicle traveling at excessive speed through a curve may be avoided by reducing its speed through automatic braking and setting a slip status at the same time, so that the lateral forces which result in tipping over are suppressed. There may also be methods that bring about comparable measures by reducing the speed initially through controlling the engine and only subsequently through action on the braking system.

A common feature such systems for avoiding rollover of a motor vehicle may be that the systems react only relatively late, for example when the grip of the wheels on one axle is already significantly reduced, in other words when the tipping process has already started.

A further measure to avoid rearward rollovers consists in increasing the mass on the front axle, but this may contradict the fundamental endeavor to reduce vehicle weight.

### SUMMARY OF THE INVENTION

The exemplary embodiment and/or exemplary method of the present invention involves using an apparatus, arrangement or structure to determine an angle of inclination θ of the vehicle, and in using the apparatus, arrangement or structure to reduce the braking force may be activated as a function of the angle of inclination θ. By measuring the angle of inclination θ, the level of underlying risk of tipping over in the instantaneous situation of the vehicle may be determined.

Evaluation of such an angle of inclination, therefore, is useful if it is desired to detect a risk of tipping over at an early stage, which is to say in the advantageous case without waiting until the tipping procedure has already started. This allows the taking of effective countermeasures against tipping over at an early stage. The angle of inclination may, for example, already be determined while the vehicle is traveling forward, such that if it subsequently travels backward the braking force at the rear wheels may be reduced from the outset. In such situations, the vehicle may be braked primarily by way of the front wheels, thus minimizing the danger of a rollover.

In an exemplary embodiment, the apparatus, arrangement or structure to reduce the braking force may be activated as a function of at least one of the following parameters: mass of the motor vehicle, height of the motor vehicle's center of gravity, speed of the motor vehicle, acceleration of the motor vehicle and direction of travel of the motor vehicle. In addition to the angle of inclination θ, which may be of particular importance in the context of the exemplary embodiment and/or exemplary method of the present invention for reducing the braking force, it may be useful if others of the parameters listed also have an impact on the decision as to whether the braking force should be reduced.

In an exemplary embodiment, the apparatus, arrangement or structure to reduce the braking force may be activated as a function of slip. While the exemplary embodiment and/or exemplary method of the present invention may be particularly useful in that it permits early detection of the risk of a rollover, the risk may be very significantly reduced if, in addition, slip is able to bring about activation of the reduction in braking force. For example, if the device determines during rearward movement and simultaneous braking that the front wheels are slipping, it may be very likely that this has to do with a severe reduction in the downward force of the front wheels, as compared with normal driving. This may be countered by lessening the braking effect at the rear wheels, in other words by reducing the braking force.

It may be particularly advantageous if the apparatus, arrangement or structure to reduce the braking force includes an apparatus, arrangement or structure to actuate at least one inlet valve and/or one outlet valve of a brake wheel cylinder. This is a particularly effective and direct way of reducing the braking pressure of one wheel, and the prerequisites needed for this, such as the ability to actuate an inlet valve of a brake wheel cylinder, are already present on most modern motor vehicles, for example as a part of ABS (anti-lock braking system), ASR (anti-spin regulation) or ESP (Electronic Stability Program). Actuating an inlet valve in such cases essentially causes the pressure to be held, while actuating an outlet valve causes the pressure to be reduced directly.

In an exemplary embodiment, the apparatus, arrangement or structure to determine an angle of inclination θ include an inclinometer. The angle of inclination θ may be measured directly and reliably by an inclinometer, which provides the best conditions for effective reduction of the danger of tipping over.

It may however also be useful if the apparatus, arrangement or structure to determine an angle of inclination θ includes an apparatus, arrangement or structure to estimate the angle of inclination θ on the basis of an estimate of masses. Estimates of masses may be carried out on the basis of the torque, the gear selected in the vehicle and the acceleration of the vehicle. Such a short-term or local estimate may then be compared with a long-term estimate over the journey. If a severe deviation occurs, this may be because the vehicle is in a position which entails a steep angle of inclination.

Estimation of masses may be done even if the vehicle drives up a hill immediately after starting. In this case, a comparison is made with the last estimate for full load. As an alternative, door switches or airbag sensors, for example, may be monitored. Such an apparatus, arrangement or structure may be used to obtain indications of a change in vehicle masses, such as may have occurred in the case of opening and subsequent closing of a door as a result of the entry or exit of a passenger. Airbag sensors provide information on the size or weight of a passenger. The position of the accelerator pedal and a corresponding acceleration of the vehicle may also be determined.

It is believed to be advantageous if the apparatus, arrangement or structure to determine an angle of inclination θ includes an apparatus, arrangement or structure to determine the speed of rotation of the engine, of the transmission and/or of the wheels. These parameters may also provide additional information on the angle of inclination θ, in particular if the latter is not measured directly. Taking account of as many parameters as possible should increase the accuracy with which the angle of inclination θ is determined.

In particular, the exemplary embodiment and/or exemplary method of the present invention may be advantageous in that an apparatus, arrangement or structure is provided to calculate a maximum braking force using the angle of inclination θ, in that an apparatus, arrangement or structure is provided to measure the instantaneous braking force, in that an apparatus, arrangement or structure is provided to compare the maximum braking force with the instantaneous braking force and in that the apparatus, arrangement or structure to reduce the braking force may be activated as a function of the comparison of the maximum braking force with the instantaneous braking force.

The maximum braking force may be calculated as a function of the angle of inclination and other vehicle parameters, such as the wheelbase and the height of the center of gravity. If the instantaneous braking force is then measured, it may be decided whether it is necessary to lessen the braking effect of the rear wheel brakes, for example when a vehicle is traveling backward.

It may also be advantageous, however, if an apparatus, arrangement or structure is provided to calculate a maximum braking force using the angle of inclination θ, if an apparatus, arrangement or structure is provided to estimate the instantaneous braking force, if an apparatus, arrangement or structure is provided to compare the maximum braking force with the instantaneous braking force and if the apparatus, arrangement or structure to reduce the braking force may be activated as a function of the comparison of the maximum braking force with the instantaneous braking force. While measurement of the braking force, for example using a wheel sensor, may give the best results under most conditions, an estimate of the braking force may also be used within the context of the exemplary embodiment and/or exemplary method of the present invention.

In an exemplary embodiment, the apparatus, arrangement or structure to reduce the braking force is assigned to one rear wheel or the rear axle. This embodiment may be advantageous because it may be suitable to a particularly useful degree when used in conjunction with an apparatus, arrangement or structure to prevent tipping over while the vehicle is traveling backward.

For the same reason, it may be advantageous that the apparatus, arrangement or structure to reduce the braking force may be activated as a function of slip at the front wheels.

The exemplary embodiment and/or exemplary method of the present invention also involves a method in which an angle of inclination θ of the vehicle is determined and in which the reduction of the braking force is activated as a function of the angle of inclination θ. By measuring the angle of inclination θ, the level of underlying risk of tipping over in the instantaneous situation of the vehicle may be determined. Evaluation of such an angle of inclination, therefore, may be useful if it is desired to detect a risk of tipping over at an early stage, which is to say in the advantageous case without waiting until the tipping procedure has already started.

This may allow the taking of effective countermeasures against tipping over at an early stage. The angle of inclination may, for example, already be determined while the vehicle is traveling forward, such that if it subsequently travels backward the braking force at the rear wheels may be reduced from the outset. In such situations, the vehicle may be braked primarily by way of the front wheels, thus minimizing the danger of a rollover.

In an exemplary embodiment, the reduction of the braking force is activated as a function of at least one of the following parameters: mass of the motor vehicle, height of the motor vehicle's center of gravity, speed of the motor vehicle, acceleration of the motor vehicle and direction of travel of the motor vehicle. In addition to the angle of inclination θ, which may be of particular importance in the context of the exemplary embodiment and/or exemplary method of the present invention for reducing the braking force, it may be useful if others of the parameters listed also have an impact on the decision as to whether the braking force should be reduced.

In an exemplary embodiment, the reduction of the braking force is activated as a function of slip. While the exemplary embodiment and/or exemplary method of the present invention may be particularly useful in that it permits early detection of the risk of a rollover, the risk may be very significantly reduced if, in addition, slip may bring about activation of the reduction in braking force. For example, if the device determines during rearward movement and simultaneous braking that the front wheels are slipping, it may be very likely that this has to do with a severe reduction in the downward force of the front wheels, as compared with normal driving. This may be countered by lessening the braking effect at the rear wheels, in other words by reducing the braking force.

It may be particularly advantageous if the reduction of the braking force takes place by actuating at least one inlet valve and/or one outlet valve of a brake wheel cylinder. This is a particularly effective and direct way of reducing the braking pressure of one wheel, and the prerequisites needed for this, such as the ability to actuate an inlet valve of a brake wheel cylinder, are already present on most modern motor vehicles, for example, as a part of ABS (anti-lock braking system), ASR (anti-spin regulation) or ESP (Electronic Stability Program). Actuating an inlet valve in such cases essentially causes the pressure to be held, while actuating an outlet valve causes the pressure to be reduced directly.

In an exemplary embodiment, the angle of inclination θ is determined by an inclinometer. The angle of inclination θ may be measured directly and reliably by an inclinometer, which may provide the best conditions for effective reduction of the danger of tipping over.

It may also be advantageous if an angle of inclination θ is determined by estimating the angle of inclination θ on the basis of an estimate of masses. Estimates of masses may be carried out on the basis of the torque, the gear selected in the vehicle and the acceleration of the vehicle. Such a short-term or local estimate may then be compared with a long-term estimate over the journey. If a severe deviation occurs, this is probably because the vehicle is in a position which entails a steep angle of inclination. Estimation of masses may be done even if the vehicle drives up a hill immediately after starting. In this case, a comparison is made with the last estimate for full load. The position of the accelerator pedal and the corresponding acceleration of a vehicle may also be measured directly.

It may also be advantageous if an angle of inclination θ is determined by determining the speed of rotation of the engine, of the transmission and/or of the wheels. These parameters may also provide additional information on the angle of inclination θ, in particular if the latter is not measured directly. Taking account of as many parameters as possible may increase the accuracy with which the angle of inclination θ is determined.

It may be advantageous if a maximum braking force is calculated using the angle of inclination θ, if the instantaneous braking force is measured, if the maximum braking force is compared with the instantaneous braking force and if the reduction of the braking force is activated as a function of the comparison of the maximum braking force with the instantaneous braking force. The maximum braking force may be calculated as a function of the angle of inclination and other vehicle parameters, such as the wheelbase and the height of the center of gravity. If the instantaneous braking force is then measured, it may be decided whether it is necessary to lessen the braking effect of the rear wheel brakes, for example while a vehicle is traveling backward.

However, it may also be advantageous if a maximum braking force is calculated using the angle of inclination θ, if the instantaneous braking force is estimated, if the maximum braking force is compared with the instantaneous braking force and if the reduction of the braking force is activated as a function of the comparison of the maximum braking force with the instantaneous braking force. While measurement of the braking force may give the best results under most conditions, an estimate of the braking force may also be used within the context of the exemplary embodiment and/or exemplary method of the present invention.

The exemplary embodiment and/or exemplary method of the present invention may be particularly advantageous in that the reduction of the braking force takes place at one rear wheel or the rear axle. This embodiment may be advantageous because the exemplary embodiment and/or exemplary method of the present invention may be suitable to a particularly useful degree when used in conjunction with an apparatus, arrangement or structure to prevent tipping over while the vehicle is traveling backward.

For the same reason it may be advantageous that the reduction of the braking force is activated as a function of slip at the front wheels.

The exemplary embodiment and/or exemplary method of the present invention is based on the finding that a quantitative description of the danger of tipping over may be given as a function of the vehicle characteristics, such as the height of the center of gravity, the vehicle mass and the vehicle geometry, and of the angle of inclination or the slope in general. For the purpose of activating the protective apparatus, arrangement or structure, in other words in the present case reducing the braking force, this quantitatively determined danger of tipping over is evaluated. This may be particularly advantageous since a risk of tipping over at an early stage may be detected to lessen the braking effect sufficiently early.

### BRIEF DESCRIPTION OF THE DRAWINGS

FIG. 1 shows a motor vehicle on a slope.

FIG. 2 shows a system diagram for describing the exemplary embodiment of the present invention.

FIG. 3 shows a flow chart for describing the exemplary method of the present invention.

### DETAILED DESCRIPTION

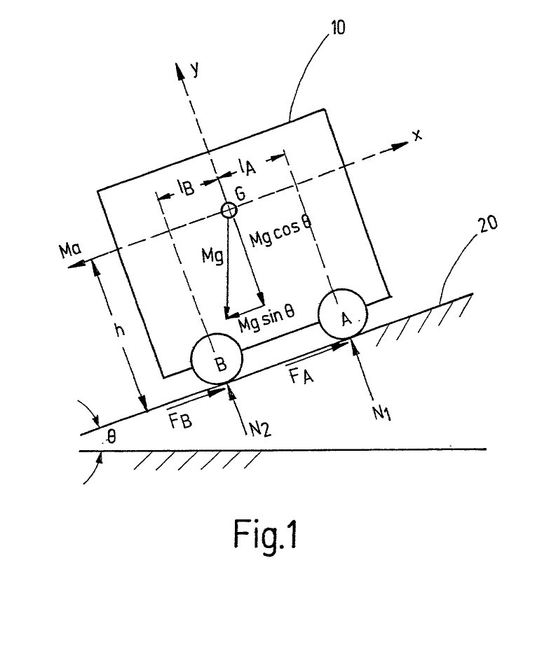

FIG. 1 shows a schematic representation of a motor vehicle which is on a sloping surface 20. A front wheel A and a rear wheel B can also be seen. Additionally, center of gravity G of motor vehicle 10 is shown. This center of gravity G is relatively high, by comparison with wheelbase 1_{B}+1_{A} of motor vehicle 10. The height of center of gravity G is shown as h. Also shown is a triangle of forces relating to the force due to weight which acts on the center of gravity G at an angle of inclination θ. Force due to weight Mg is divided into the components Mg cos θ and Mg sin θ, with Mg cos θ being the vertical component relative to motor vehicle 10 and Mg sin θ being the horizontal compartment relative to motor vehicle 10.

In the schematic representation according to FIG. 1, forces are also shown which relate to a situation in which braking is applied to motor vehicle 10 while it is moving backward. Perpendicular force N₁ is the force which bears vertically from front wheel A onto sloping surface 20. Perpendicular force N₂ is the force which bears vertically from rear wheel B onto sloping surface 20. Force F_{A} is the braking force acting on front wheel A. Force F_{B} is the braking force acting on rear wheel B. Force Ma is the inertia acting on the center of gravity of the vehicle and generated by the braking of motor vehicle 10.

Using mechanical theory to take into account the equilibrium of forces and torques gives the following relationships:

N₁+N₂₌Mg cos θ (1)

F_{A}+F_{B}−Mg sin θ=Ma (2)

h(F_{A}+F_{B})−1_{B}N₂+1_{A}N₁=0 (3)

If after transformation, equation (1) is applied in equation (3), the result is:

N₁(1_{A}+1_{B})=1_{B}Mg cos θ−h(F_{A}+F_{B}) (4)

There is a risk of tipping over when perpendicular force N₁ applied by front wheel A to sloping surface 20 approaches zero. In this case, braking force F_{A} acting on the front wheel also approaches zero. In this case of risk of tipping over, equation (4) gives the following:

0=1_{B}Mg cos θ−hF_{B} (5)

From equation (5), maximum permissible braking force F_{Bmax} at the rear axle is able to be determined as a function of the wheelbase, the height of the center of gravity, the mass of the vehicle and the angle of inclination of sloping surface 20.

$${F}_{B max} = \frac{{1}_{B}}{h} \cdot Mg cos θ \qquad ( 6 )$$

Applying equation (6) in equation (2), with allowance being made for F_{A} approaching zero in the event that the motor vehicle tips over, gives a value for maximum retardation aₘₐₓ:

$${a}_{max} = \frac{{F}_{B max}}{M} + Mg sin θ \qquad ( 7 )$$

An advantageous variant of the exemplary embodiment and/or exemplary method of the present invention involves measuring the braking force acting on rear wheel B or the rear wheels, and reducing the braking force until measured braking force F_{Bmess} is less than maximum braking force F_{Bmax}. In an exemplary embodiment, allowance is made for an additional safety parameter δ, so that in any event a safe situation should or will prevail, provided that:

F_{Bmess}<F_{Bmax}+δ (8)

For example, δ allows for inaccuracies in the estimation or measurement of the angle of inclination θ, or inaccuracies with regard to variations in the mass of the vehicle or the height of the center of gravity.

In addition to using the inequality (8), the reduction of the braking force may also take place on the basis of observation of the behavior of the front wheels. If, for example, the front axle begins to lift, the front wheels experience slip. As soon as this is detected, it is possible to reduce the braking force, for example by closing the inlet valves. The reduction of the braking force may then be made dependent on there being no more slip detected at the front wheels.

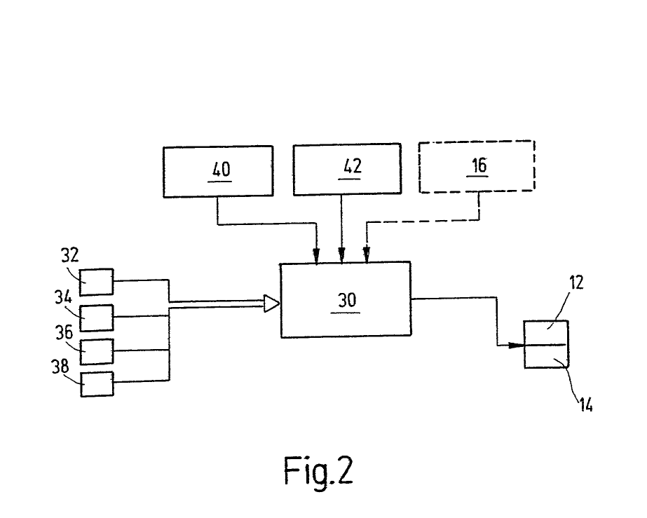

FIG. 2 shows a system circuit diagram to explain the exemplary embodiment of the present invention. The speeds of rotation of the motor vehicle's four wheels 32, 34, 36, 38 are supplied as inputs to a controller 30. Additional input data comes, for example, from an engine controller 40 and from transmission 42. This input data may be used in order to carry out the calculations or estimations which are necessary for deciding that a braking force should be reduced. It is also useful for input values from an inclination sensor 16 to be supplied to the controller. This provides for measured values for angle of inclination θ, rather than estimated values, to be used in controller 30. Angle of inclination θ may also be measured in addition to being estimated.

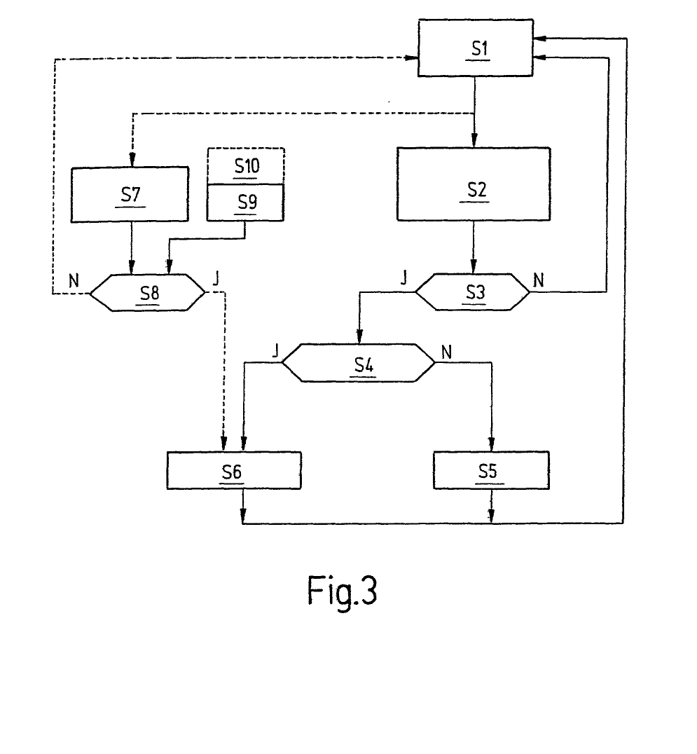

FIG. 3 shows a flow chart to explain the exemplary method of the present invention.

The steps of the flow diagram as shown in FIG. 3 comprise the following measures:

S1: Detection of the speed of rotation of the engine, of the transmission and of the wheels

S2: Calculation of the motor vehicle's speed, acceleration and direction

S3: Backward?

S4: Front drive slip during braking?

S5: Do not restrict pressure buildup

S6: Hold F_{B} by closing one or more inlet valves or reduce F_{B} by opening one or more outlet valves

S7: Calculation of F_{Bmax} and aₘₐₓ

S8: F_{B}>Fₘₐₓ? or a>aₘₐₓ?

S9: Estimation of F_{B}

S10: Measurement of F_{B}

The elements, features or steps of the flow chart shown in broken lines may be used as an alternative or as an addition to the elements, features or steps shown in continuous lines.

In a step S1, certain parameters are detected, such as the speeds of rotation of the engine, the transmission and the wheels. The mass, the height of the center of gravity and angle of inclination θ are deduced therefrom, it also being possible to measure angle of inclination θ.

In step S2 the speed of the motor vehicle, its acceleration and its direction of travel are calculated.

Step S3 determines whether the vehicle is traveling forward or backward. If the vehicle is traveling forward, there is no reason to prevent a tipping over of the vehicle rearward, and the sequence returns to step S1. If the vehicle is traveling backward, step S4 determines whether there is slip at the front wheel drive during braking. If there is no slip at the front wheel drive, step S5 causes the pressure buildup in the rear wheels not to be restricted, and the sequence returns to step S1. If step S4 determines that there is slip at the front wheels, in step 6 the braking force on the rear wheels is held essentially constant by closing the inlet valves and/or is reduced by opening the outlet valves. After that the sequence returns to step S1.

The values detected in step S1 may also be used in a step S7 to calculate maximum braking force F_{Bmax} or maximum retardation aₘₐₓ according to equations (6) and (7) above. A step S8 determines whether a braking force F_{B} actually present, for example having been measured, is greater than maximum braking force F_{Bmax}. Value F_{B} used for the comparison in step S8 is estimated in step S9 or measured in step S10. If this is the case, the sequence moves to step S6 and braking force F_{B} is reduced by closing one or more inlet valves. If braking force F_{B} is not greater than F_{Bmax} or than the total of F_{Bmax} and a safety parameter δ, the sequence moves to step S1.

The preceding description of the exemplary embodiment and/or exemplary method of the present invention are not intended to be limiting, since various alterations and modifications may be made within the proper scope of the subject matter.

What is claimed is:

1. A system for avoiding a rollover during a braking of a motor vehicle, the system comprising:
a first arrangement to reduce a braking force at at least one wheel, wherein the first arrangement includes a second arrangement to determine an angle of inclination of the vehicle, and the first arrangement to reduce the braking force is activatable as a function of the angle of inclination.

2. The system of claim 1, wherein the first arrangement to reduce the braking force is activatable as a function of at least one of a mass of the motor vehicle, a height of the motor vehicle's center of gravity, a speed of the motor vehicle, an acceleration of the motor vehicle and a direction of travel of the motor vehicle.

3. The system of claim 1, wherein the first arrangement to reduce the braking force is activatable as a function of a slip.

4. The system of claim 1, wherein the first arrangement to reduce the braking force includes a third arrangement to actuate at least one of at least one inlet valve and one outlet valve of a brake wheel cylinder.

5. The system of claim 1, wherein the second arrangement to determine the angle of inclination includes an inclinometer.

6. The system of claim 1, wherein the second arrangement to determine the angle of inclination includes a third arrangement to estimate the angle of inclination based on an estimate of mass.

7. The system of claim 1, wherein the second arrangement to determine the angle of inclination includes a third arrangement to determine a speed of rotation of at least one of an engine, a transmission and at least one wheel of the vehicle.

8. The system of claim 1, further comprising:
a third arrangement to calculate a maximum braking force using the angle of inclination;
a fourth arrangement to measure the instantaneous braking force; and
a fifth arrangement to compare the maximum braking force with the instantaneous braking force;
wherein the first arrangement to reduce the braking force is activatable as a function of a comparison of the maximum braking force with the instantaneous braking force.

9. The system of claim 1, further comprising:
means for calculating a maximum braking force using the angle of inclination;
means for measuring the instantaneous braking force; and
means for comparing the maximum braking force with the instantaneous braking force;
wherein the first arrangement to reduce the braking force is activatable as a function of a comparison of the maximum braking force with the instantaneous braking force.

10. The system of claim 1, wherein the first arrangement reduce the braking force is assigned to one of one rear wheel and a rear axle.

11. The system of claim 1, wherein the first arrangement to reduce the braking force is activated as a function of a slip at a front wheel.

12. A method to avoid a rollover during a braking of a motor vehicle in which a braking force is reduced at at least one wheel, the method comprising:
determining an angle of inclination of the motor vehicle; and
activating a reduction of the braking force as a function of the angle of inclination.

13. The method of claim 12, wherein the reduction of the braking force is activated as a function of at least one of a mass of the motor vehicle, a height of the motor vehicle's center of gravity, a speed of the motor vehicle, an acceleration of the motor vehicle and a direction of travel of the motor vehicle.

14. The method of claim 12, wherein the activating of reduction of the braking force is as a function of a slip.

15. The method of claim 12, wherein the activating of the reduction of the braking force is performed by actuating at least one of at least one inlet valve and one outlet valve of a brake wheel cylinder.

16. The method of claim 12, wherein the determining of the angle of inclination is performed using an inclinometer.

17. The method of claim 12, wherein the determining of the angle of inclination includes estimating the angle of inclination based on an estimate of mass.

18. The method of claim 12, wherein the determining of the angle of inclination includes determining a speed of rotation of at least one of an engine, a transmission and at least one wheel of the vehicle.

19. The method of claim 12, further comprising:
determining a maximum braking force using the angle of inclination;
measuring an instantaneous braking force; and
comparing the maximum braking force with the instantaneous braking force;
wherein a reduction of the braking force is based on a function of a comparison of the maximum braking force with the instantaneous braking force.

20. The method of claim 16, further comprising:
determining a maximum braking force using the angle of inclination;
measuring an instantaneous braking force; and
comparing the maximum braking force with the instantaneous braking force;
wherein a reduction of the braking force is based on a function of a comparison of the maximum braking force with the instantaneous braking force.

21. The method of claim 12, wherein the reduction of the braking force takes place at one of one rear wheel and a rear axle.

22. The method of claim 12, wherein the activating of the reduction of the braking force is as a function of slip at at least one front wheel.
